(19) United States
(12) Patent Application Publication
(10) Pub. No.: US 2026/0319099 A1
(43) Pub. Date: Oct. 15, 2026

(54) INFORMATION PROCESSING METHOD, INFORMATION PROCESSING DEVICE, AND PROGRAM

(71) Applicant: SONY GROUP CORPORATION, TOKYO (JP)

(72) Inventors: TAKUTO MOTOYAMA, TOKYO (JP); MASASHI ESHIMA, TOKYO (JP); SHINGO TSURUMI, TOKYO (JP); EISUKE NOMURA, TOKYO (JP); MASAHIKO TOYOSHI, TOKYO (JP); TAKASHI KONNO, TOKYO (JP)

(21) Appl. No.: 19/483,757

(22) PCT Filed: May 9, 2024
(86) PCT No.: PCT/JP2024/017203

§ 371 Date: Nov. 12, 2025

(30) Foreign Application Priority Data
May 23, 2023 (JP) 2023-084329

(51) Int. Cl. G01S 17/933; G01S 17/32; G01S 17/58

(52) U.S. Cl. CPC G01S 17/933; G01S 17/32; G01S 17/58

(57) ABSTRACT

The present technology relates to an information processing method, an information processing device, and a program that enable immediate detection of a moving object. Provided acquires information for predicting a motion of an object located in a surrounding from a frequency modulated continuous wave light detection and ranging (FMCW LiDAR); detects the object using the information; and predicts the motion of the object with different prediction accuracy according to the number of distance measurement points of the FMCW LIDAR on the object. In a case where the distance measurement point of the FMCW LiDAR is one point on the object, the present technology in which the direction in which the plane including the candidate vector that may be the motion vector representing the direction in which the object is moving is located is set as the prediction result of the motion of the object can be applied to, for example, a drone that autonomously moves.

### TECHNICAL FIELD

The present technology relates to an information processing method, an information processing device, and a program, and for example, relates to an information processing method, an information processing device, and a program capable of immediately detecting an obstacle and appropriately planning a trajectory capable of avoiding an obstacle when planning a trajectory that is a movement route in a moving body.

### BACKGROUND ART

When planning a trajectory that is a movement route to a destination, a moving body that autonomously moves plans the trajectory so as to avoid surrounding obstacles. Patent Document 1 proposes detecting an obstacle using images acquired at different timings.

### CITATION LIST

### Patent Document

Patent Document 1: Japanese Patent Application Laid-Open No. 2023-021910

### SUMMARY OF THE INVENTION

### Problems to be Solved by the Invention

In Patent Document 1, since an obstacle is detected using images acquired at different timings, detection cannot be performed until a plurality of images is acquired, and there has been a possibility that detection of an obstacle moving at a high speed is delayed, for example. It is desired to be able to immediately detect an obstacle and plan an optimal trajectory.

The present technology has been made in view of such a situation, and an object thereof is to be able to immediately detect an obstacle.

### Solutions to Problems

An information processing method according to one aspect of the present technology is an information processing method including: acquiring information for predicting a motion of an object located in a surrounding from a frequency modulated continuous wave light detection and ranging (FMCW LIDAR); detecting the object using the information; and predicting the motion of the object with different prediction accuracy according to the number of distance measurement points of the FMCW LiDAR on the object.

An information processing device according to one aspect of the present technology is an information processing device including: a detection unit that acquires information for predicting a motion of an object located around a moving body from a frequency modulated continuous wave light detection and ranging (FMCW LiDAR) included in the moving body, and detects the object using the information; and a prediction unit that predicts the motion of the object with different prediction accuracy according to the number of distance measurement points of the FMCW LiDAR on the object detected by the detection unit.

A program according to one aspect of the present technology is a program for causing a computer to execute processing including the steps of: acquiring information for predicting a motion of an object located in a surrounding from a frequency modulated continuous wave light detection and ranging (FMCW LiDAR); detecting the object using the information; and predicting the motion of the object with different prediction accuracy according to the number of distance measurement points of the FMCW LiDAR on the object.

In the information processing method, the information processing device, and the program according to one aspect of the present technology, information for predicting the motion of an object located in the surrounding is acquired from the FMCW LiDAR, the object is detected using the information, and the motion of the object is predicted with different prediction accuracy according to the number of distance measurement points of the FMCW LiDAR on the object.

Note that the information processing device may be an independent device or may be an internal block constituting a device.

Note that a program to be provided may be transmitted via a transmission medium or be stored in a storage medium.

### BRIEF DESCRIPTION OF DRAWINGS

FIG. 1 is a diagram for explaining an avoidance action.

FIG. 2 is a diagram illustrating a configuration of an embodiment of a moving body to which the present technology is applied.

FIG. 3 is a flowchart for explaining an operation of the moving body.

FIG. 4 is a diagram for explaining an operation of an FMCW LiDAR.

FIG. 5 is a diagram for explaining an operation of the EMCW LiDAR.

FIG. 6 is a diagram for explaining a motion component.

FIG. 7 is a diagram for explaining a motion component.

FIG. 8 is a diagram for explaining detection of an instance.

FIG. 9 is a diagram for explaining estimation of a motion direction.

FIG. 10 is a diagram for explaining estimation of a motion direction.

FIG. 11 is a diagram for explaining estimation of a motion direction.

FIG. 12 is a diagram for explaining estimation of a motion direction.

FIG. 13 is a diagram for explaining estimation of a motion direction in a case where a distance measurement point is one point.

FIG. 14 is a diagram for explaining trajectory planning in a case where a distance measurement point is one point.

FIG. 15 is a diagram for explaining estimation of a motion direction in a case where distance measurement points are two points.

FIG. 16 is a diagram for explaining trajectory planning in a case where distance measurement points are two points.

FIG. 17 is a diagram for explaining trajectory planning in a case where distance measurement points are two points.

FIG. 18 is a diagram for explaining estimation of a motion direction in a case where distance measurement points are three points.

FIG. 19 is a diagram for explaining trajectory planning in a case where distance measurement points are three points.

FIG. 20 is a diagram illustrating another configuration of the moving body to which the present technology is applied.

FIG. 21 is a diagram for explaining detection of an instance.

FIG. 22 is a flowchart for explaining an operation of the moving body.

FIG. 23 is a diagram for explaining a tracking operation.

FIG. 24 is a diagram for explaining a configuration of a PC.

### MODE FOR CARRYING OUT THE INVENTION

Hereinafter, modes (hereinafter, referred to as embodiments) for implementing the present technology will be described.

### Outline of Present Disclosure

The present disclosure enables a moving body that autonomously moves to appropriately plan a trajectory that is a movement route for avoiding an obstacle according to a surrounding situation. Here, the description will be continued by taking a drone as an example of the moving body, but the present technology can also be applied to a moving body other than the drone.

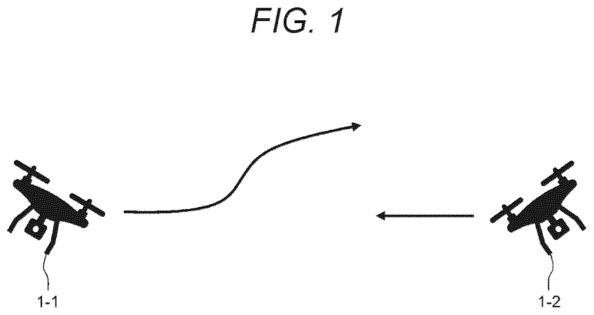

As illustrated in FIG. 1, a case is considered where a moving body 1-1 and a moving body 1-2 are in a flying state, and the moving body 1-1 and the moving body 1-2 are flying opposite to each other. In a case where the moving body 1-1 and the moving body 1-2 approach each other, and there is a possibility of collision if the moving body 1-1 and the moving body 1-2 travel as it is, the moving body 1-1 changes its course to a direction to avoid the moving body 1-2.

In particular, in a case where the moving body 1-1 and the moving body 1-2 fly opposite to each other, a relative velocity between the moving body 1-1 and the moving body 1-2 becomes high, and thus, it is desirable that such an avoidance action be immediately performed. In the moving body 1 to which the present technology is applied, such an avoidance action can be immediately performed.

### Configuration of Moving Body

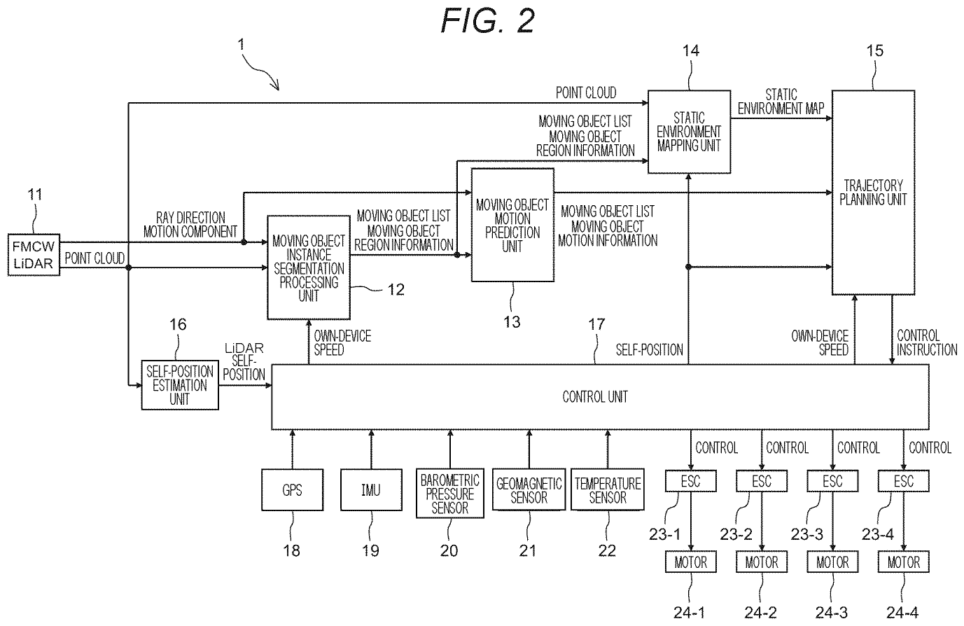

FIG. 2 is a diagram illustrating a configuration of an embodiment of a moving body to which the present technology is applied.

The moving body 1 includes a frequency modulated continuous wave light detection and ranging (FMCW LiDAR) 11, a moving object instance segmentation processing unit 12, a moving object motion prediction unit 13, a static environment mapping unit 14, a trajectory planning unit 15, a self-position estimation unit 16, a control unit 17, a global positioning system (GPS) 18, an inertial measurement unit (IMU) 19, a barometric pressure sensor 20, a geomagnetic sensor 21, a temperature sensor 22, an electronic stability control (ESC) 23-1 to 23-4, and motors 24-1 to 24-4.

Each unit of the moving body 1 illustrated in FIG. 2 may be entirely included in the moving body 1, or some units of the moving body 1 may be configured as another device. For example, some or all of the moving object instance segmentation processing unit 12, the moving object motion prediction unit 13, the static environment mapping unit 14, and the trajectory planning unit 15 may be mounted on an information processing device different from the moving body 1, and data may be exchanged between the moving body 1 and the information processing device.

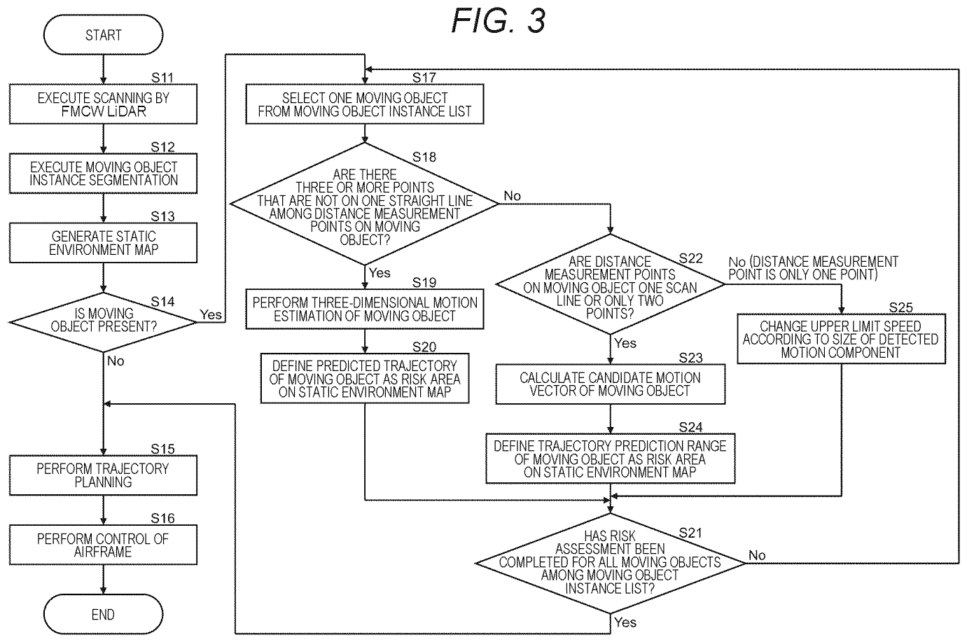

The operation of the moving body 1 will be described with reference to the flowchart of FIG. 3.

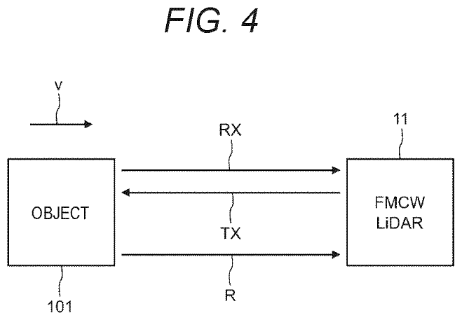

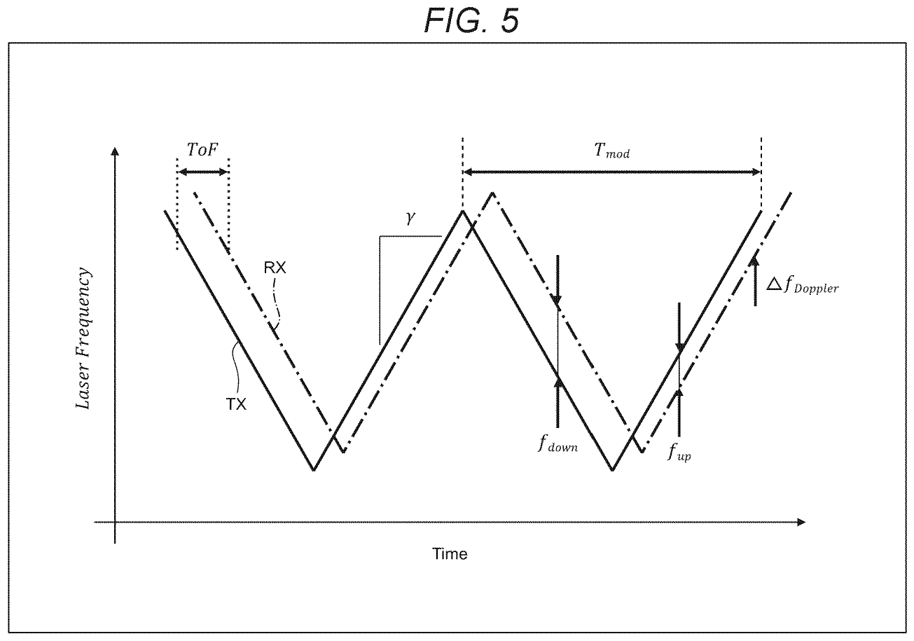

In step S11, the FMCW LiDAR 11 executes scanning. The FMCW LiDAR 11 performs distance measurement by an FMCW LiDAR method (frequency continuous modulation method). In the FMCW LiDAR method, frequency modulation of a light source is performed, and distance measurement is performed by reading a change in frequency between the modulated transmission light and its reflected light. Here, the measurement principle by the FMCW LiDAR 11 will be described with reference to FIGS. 4 and 5. As illustrated in FIG. 4, in measuring a distance R to an object 101 to be measured and relative velocity v with respect to the object 101, a case is assumed where the FMCW LIDAR 11 emits transmission light (TX light) and receives reception light (RX light) as reflected light thereof.

FIG. 5 illustrates a relationship between transmission light and reception light when the vertical axis represents a laser frequency and the horizontal axis represents time. In FIG. 5, a solid triangle wave represents transmission light (TX light), and a dashed-dotted triangle wave represents reception light (RX light).

At this time, the chirp includes a period (down chirp) in which the optical frequency is lowered and a period (up chirp) in which the optical frequency is raised, and a period (Tmod in FIG. 4) in which the down chirp and the up chirp are combined corresponds to the distance measurement at one point. Such a LiDAR method for performing distance measurement using chirp light is referred to as the FMCW LiDAR method.

By measuring the beat frequency in the down chirp (fdown in FIG. 5) and the beat frequency in the up chirp (fup in FIG. 5), the distance R from the FMCW LiDAR 11 to the object 101 and the relative velocity v between the FMCW LiDAR 11 and the object 101 can be calculated using the following Expressions (1) and (2).

fdown+fup=4γR/c (1)

In Expression (1), R represents the distance [m] from the FMCW LiDAR 11 to the object 101. Furthermore, γ represents a chirp speed [Hz/s], and c represents the speed of light [m/s] . Note that ToF in FIG. 5 can be expressed as τ=2R/c, and the right side of Expression (1) is derived from the relationship between τ and γ.

Fdown−Fup=2v/λlaser (2)

In Expression (2), v represents a relative velocity [m/s] between the FMCW LiDAR 11 and the object 101. Furthermore, λlaser represents the center wavelength [mm] of the light source. Note that ΔfDoppler in FIG. 5 can be expressed as ΔfDoppler=(v/c) flaser, and the right side of Expression (2) is derived from these relationships.

The distance R and the relative velocity v can be obtained using Expressions (1) and (2). By the measurement by the FMCW LIDAR 11, information regarding the moving direction of the object 101 is also obtained. Since the FMCW LIDAR 11 uses a method of estimating a distance from a change in frequency, environmental robustness against bad weather such as fog or rainy weather is also high. Furthermore, the FMCW LIDAR 11 can also estimate motion information in each ray direction from Doppler information.

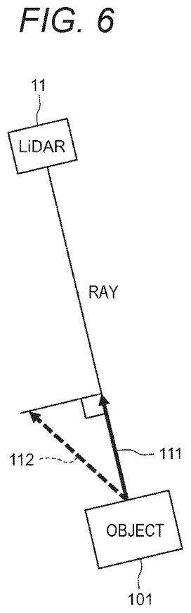

The estimation of the motion information will be described with reference to FIG. 6. A motion vector 111 (denoted as an F motion vector 111) on the ray connecting the ray from the FMCW LiDAR 11 and the object 101 is motion information obtained from the EMCW LiDAR 11. In a case where the object 101 is moving in the direction and speed represented by a motion vector 112, this motion vector 112 (referred to as an actual motion vector 112) represents the actual motion of the object 101 as viewed from the FMCW LiDAR 11.

A motion component obtained by projecting the actual motion vector 112 onto the ray is the F motion vector 111. The FMCW LIDAR 11 can acquire the F motion vector 111 in the ray direction as motion information, and acquire information on the motion direction and the speed of the object 101, that is, information represented by the actual motion vector 112 from the motion information.

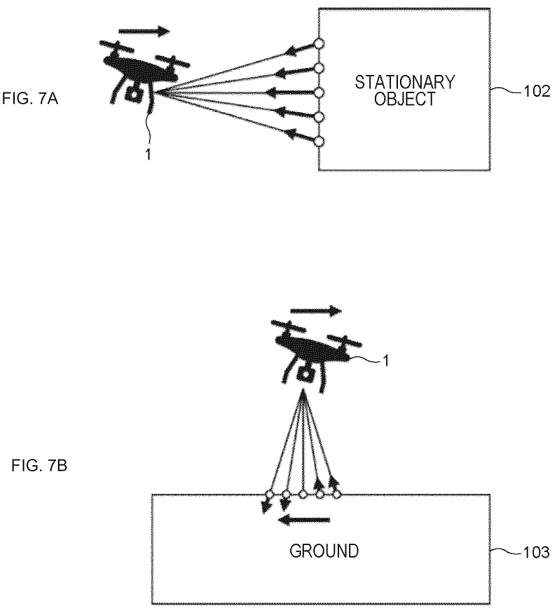

With reference to FIG. 7, the fact that the motion component differs according to the moving direction of the moving body 1 equipped with the FMCW LIDAR 11 with respect to the object will be described. A of FIG. 7 illustrates a situation in which the moving body 1 is moving in the direction of the stationary object 102. In a case where the moving direction of the moving body 1 and the surface of the stationary object 102 on the moving body 1 side are nearly perpendicular to each other, a motion component in the ray direction as indicated by the arrow is obtained. In this case, the motion component in the ray direction, that is, the vector corresponding to the F motion vector 111 described with reference to FIG. 6 can be obtained with high accuracy. By obtaining the F motion vector 111 with high accuracy, the motion information of the object, that is, the information of the actual motion vector 112 can also be obtained with high accuracy.

B of FIG. 7 illustrates a situation in which the moving body 1 moves in parallel with a stationary object 103, for example, the ground. In a case where the moving direction of the moving body 1 and the surface of the stationary object 103 on the moving body 1 side are in a state of being close to parallel, a motion component in the ray direction as indicated by the arrow is obtained. In this case, the motion component in the ray direction, that is, the vector corresponding to the F motion vector 111 described with reference to FIG. 6 becomes small (becomes a value close to zero), and the motion information of the object, that is, the information of the actual motion vector 112 also becomes small.

From the above, in a case where there is an object that approaches the moving body 1, it is considered that while the moving direction and the speed of the approaching object can be detected with high accuracy, for an object that is parallel to the moving body 1, there is a possibility that the detection of the moving direction and the speed of the object is less accurate. For example, in a case where there is an object that may approach the moving body 1, when the object is detected and an avoidance action is taken so as not to collide with the object, by using the FMCW LIDAR 11, it is possible not to detect the object that may not collide while detecting the object that may collide.

According to the moving body 1 including the FMCW LiDAR 11, it is possible to detect a moving direction and speed of a surrounding object (obstacle), determine whether or not there is a possibility of approaching the detected object, plan a trajectory not approaching the detected object in a case where there is a possibility of approaching the object, and move on the basis of the planned trajectory. Furthermore, since such object detection can be performed using a single frame (one frame) as described later, the time from the detection to the planning of the trajectory can be shortened.

The description returns to the flowchart illustrated in FIG. 3. In step S11, scanning by the EMCW LiDAR 11 is executed, and the distance measurement data obtained as a result of the scanning is supplied as a point cloud to the moving object instance segmentation processing unit 12 and the self-position estimation unit 16. Furthermore, the FMCW LIDAR 11 also outputs a motion component in the ray direction, that is, information corresponding to the F motion vector 111, and the motion component in the ray direction is supplied to the moving object instance segmentation processing unit 12 and the moving object motion prediction unit 13.

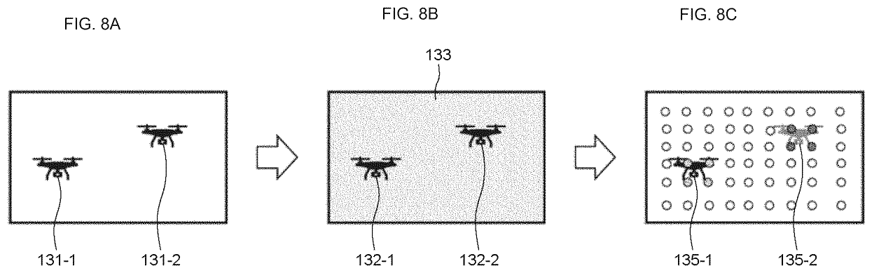

In step S12, the moving object instance segmentation processing unit 12 executes moving object instance segmentation processing. Processing performed by the moving object instance segmentation processing unit 12 will be described with reference to FIG. 8.

A of FIG. 8 illustrates an image within the angle of view of the FMCW LiDAR 11 of the moving body 1, and illustrates a state in which a moving object 131-1 and a moving object 131-2 are flying. In such a state, in a case where scanning by the FMCW LIDAR 11 is performed and the point cloud data and the motion component in the ray direction are acquired, the moving object instance segmentation processing unit 12 executes processing of dividing a moving object region and a static region using these data.

The own-device speed is canceled from the motion component of each point cloud obtained from the FMCW LiDAR 11, the region where the motion component remains becomes the moving object region, and the region where the motion Component does not remain becomes the static region. As illustrated in B of FIG. 8, a region corresponding to the moving object 131-1 is detected as a moving object region 132-1, and a region corresponding to the moving object 131-2 is detected as a moving object region 132-2. Regions other than the moving object region 131-1 and the moving object region 131-2 are detected as a static region 133.

Since the data in the point cloud is obtained from the FMCW LIDAR 11, as illustrated in C of FIG. 8, a group of point clouds located in the region determined as the moving object region 131 and having a short distance or a group of point clouds in the region in which motion components are closed is treated as one instance 135. In the example illustrated in C of FIG. 8, a group of point clouds in the moving object region 132-1 is treated as an instance 135-1, and a group of point clouds in the moving object region 132-2 is treated as an instance 135-2.

In step S12, when the moving object instance segmentation is executed by the moving object instance segmentation processing unit 12 and the instance 135 is detected as described with reference to FIG. 8, the process proceeds to step S113. In step S113, the static environment mapping unit 14 creates a static environment map.

The ray direction motion component is supplied from the FMCW LIDAR 11, and the moving object list and the moving object region information are supplied from the moving object instance segmentation processing unit 12 to the static environment mapping unit 14. For example, as illustrated in C of FIG. 8, in a case where the instance 135-1 and the instance 135-2 are detected, the moving object list and the moving object region information are a list describing that the two instances are detected as the moving objects, and are information that can uniquely specify the region (a group of point cloud data) detected as the instance 135.

In the point cloud obtained from the FMCW LiDAR 11, the static environment mapping unit 14 generates the static environment map by removing the point cloud in the region of the moving object and temporally accumulating the remaining point cloud in the stationary region. The generated static environment map may be a point cloud map (accumulation of a point cloud using a self-position) or may be a map called an occupancy grid map in which the map is divided in units of voxels and an occupancy probability of each voxel is obtained. The static environment map generated by the static environment mapping unit 14 is supplied to the trajectory planning unit 15.

In step S13, when the static environment map is generated by the static environment mapping unit 14, the process proceeds to step S14. In step S14, the moving object motion prediction unit 13 determines whether or not a moving object is present. In this determination, the moving object list is referred to, and in a case where the moving object is described in the moving object list, it is determined that there is a moving object, and in a case where the moving object is not described in the moving object list, it is determined that there is no moving object.

In a case where it is determined in step S14 that the moving object is not present, the process proceeds to step S15. In step S15, the trajectory planning unit 15 plans a trajectory. The trajectory planning unit 15 determines the direction and the speed in which the own device travels by using the static environment map supplied from the static environment mapping unit 14, the moving object list and the moving object motion information supplied from the moving object instance segmentation processing unit 12, and the self-position and the own device speed supplied from the control unit 17.

Here, since no moving object is detected, the moving object list and the moving object motion information supplied from the moving object instance segmentation processing unit 12 are information indicating that no moving object is detected. The trajectory planning unit 15 refers to the stationary environment map, determines a trajectory and speed that do not approach the stationary object, generates a control instruction, and supplies the control instruction to the control unit 17.

In step S16, the control unit 17 performs control of the air frame on the basis of the control instruction supplied from the trajectory planning unit 15. The control unit 17 controls the attitude, speed, and the like of the air frame. The control unit 17 calculates the self-position and the self-speed by using information obtained from the self-position estimation unit 16, the GPS 18, the IMU 19, the barometric pressure sensor 20, the geomagnetic sensor 21, the temperature sensor 22, and the like. The control unit 17 controls the ESCs 23-1 to 23-4, and the attitude and the speed of the air frame are controlled by driving the motors 24-1 to 24-4 on the basis of the control of the ESCs 23-1 to 23-4.

On the other hand, in step S14, in a case where the moving object motion prediction unit 13 determines that the moving object is present, the process proceeds to step S17. In step S17, one moving object (instance) is selected from the moving object list. The moving object motion prediction unit 13 selects one instance from the instances described in the moving object list supplied from the moving object instance segmentation processing unit 12, and sets the selected instance as a processing target.

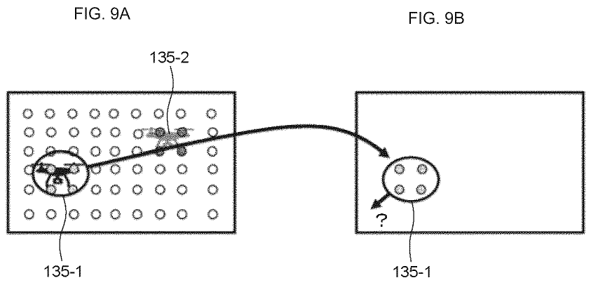

In the processing of steps S18 to S25, the moving object motion prediction unit 13 predicts the moving direction and the speed of the moving object, that is, the motion of the moving object. The processing related to the prediction of the motion of the moving object will be described with reference to FIG. 9 and the subsequent drawings.

A of FIG. 9 is the same diagram as C of FIG. 8, and is a diagram illustrating an example of a detected instance. As illustrated in A of FIG. 9, the instance 135-1 and the instance 135-2 are detected, and these two pieces of information are described in the moving object list. In a case where the moving object motion prediction unit 13 selects the instance 135-1 as a selection target from this moving object list, as illustrated in B of FIG. 9, a group of point clouds constituting the instance 135-1 is used, and it is estimated in which direction and at what speed the instance 135-1 moves.

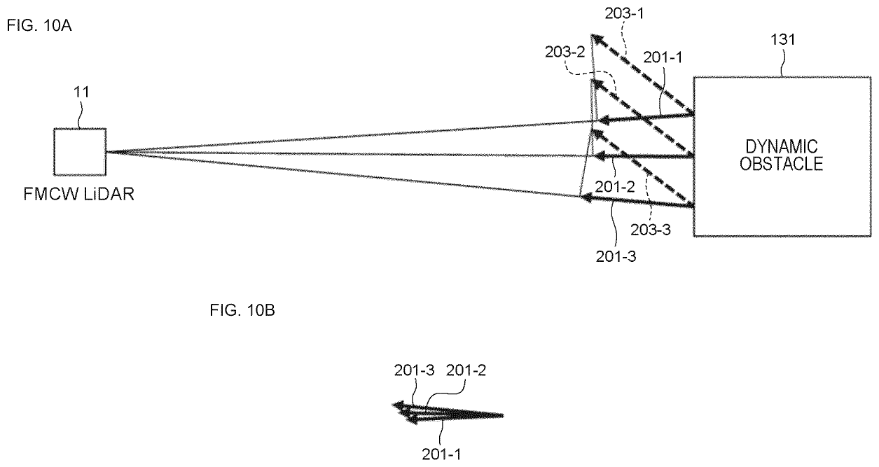

The estimation of the moving direction and the speed of the object will be described with reference to FIG. 10. As described with reference to FIG. 6, the FMCW LiDAR 11 acquires a motion component in the ray direction, and the motion component in the ray direction is a vector obtained by projecting, onto the ray, a motion vector representing the direction and the speed in which the object is actually moving. A of FIG. 10 illustrates a situation in which the object (dynamic obstacle) 131 is irradiated with light from the FMCW LiDAR 11, and motion vectors (F motion vectors) 201-1 to 201-3 in the ray direction of the light are obtained.

The F motion vector 201-1 is a component obtained by projecting an actual motion vector (actual motion vector) 203-1 (hereinafter, the actual motion vector is indicated by a dotted arrow) of the moving object 131 in the ray direction. The F motion vector 201-2 is a component obtained by projecting an actual motion vector 203-2 of the moving object 131 in the ray direction. The F motion vector 201-3 is a component obtained by projecting an actual motion vector 203-3 of the moving object 131 in the ray direction.

In this way, the actual motion vector 203 representing the actual motion of the moving object 131 can be obtained from a plurality of the F motion vectors 201 obtained by irradiating the moving object 131 with light. Since the velocity component obtained from the Doppler information of each point cloud of the FMCW LiDAR 11 is a component obtained by projecting the relative motion vector with the actual moving object 131 in the ray direction, there may be an error from the actual relative motion. Therefore, by estimating the actual relative motion using the Doppler information obtained from a plurality of points, that is, three pieces of information in the example illustrated in FIG. 10, it is possible to obtain the relative motion with less error.

B of FIG. 10 is a diagram in which the start points of the F motion vectors 201-1 to 201-3 obtained by the FMCW LiDAR 11 are matched. As the angle between the ray direction (the F motion vector 201) and the actual motion vector 203 decreases, the length of the F motion vector 201 increases. From this, it can be estimated that the moving object 131 moves in the direction in which the F motion vector 201 is the longest. In the example illustrated in B of FIG. 10, since the F motion vector 201-3 is the longest, it can be estimated that the moving object 131 is moving in the direction of the F motion vector 201-3.

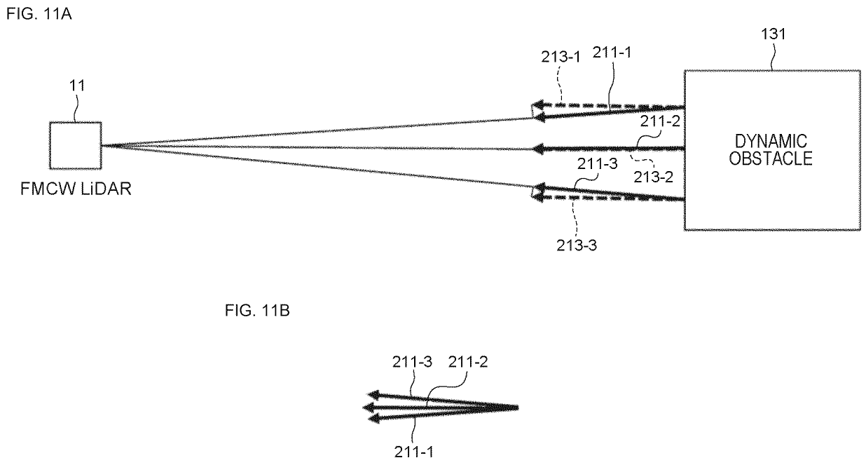

The example illustrated in FIG. 10 illustrates a case where the moving object 131 moves in the upper direction with respect to the FMCW LiDAR 11 (the moving body 1 on which the FMCW LiDAR 11 is mounted). A case where the moving object 131 is moving in a direction toward the FMCW LiDAR 11 (the moving body 1 on which the FMCW LiDAR 11 is mounted) will be described with reference to FIG. 11.

A of FIG. 11 illustrates a situation in which the object (dynamic obstacle) 131 is irradiated with light from the FMCW LIDAR 11, and F motion vectors 211-1 to 211-3 in the ray direction of the light are obtained. The F motion vector 211-1 is a component obtained by projecting an actual motion vector 213-1 of the moving object 131 in the ray direction. Since the F motion vector 211-2 is a component obtained by projecting an actual motion vector 213-2 of the moving object 131 in the ray direction and is in the same direction as the F motion vector 211-2 in A of FIG. 11, the F motion vector 211-2 is overlapped with the actual motion vector 213-2. The F motion vector 211-3 is a component obtained by projecting an actual motion vector 213-3 of the moving object 131 in the ray direction.

B of FIG. 11 is a diagram in which the start points of the F motion vectors 211-1 to 211-3 obtained by the FMCW LiDAR 11 are matched. In the example illustrated in B of FIG. 11, since the F motion vector 211-2 is the longest, it can be estimated that the moving object 131 is moving in the direction of the F motion vector 211-2. The F motion vector 211-2 is a direction toward the moving body 1, and in such a case, the F motion vector 211 is the largest.

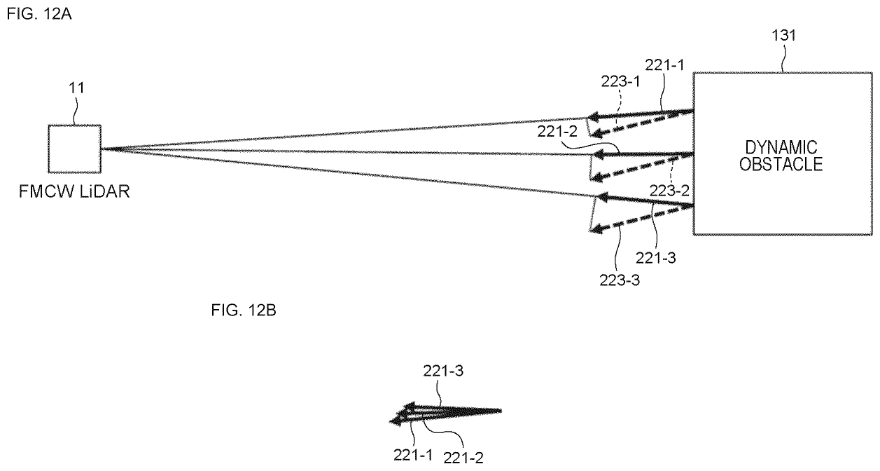

A case where the moving object 131 is moving in the lower direction with respect to the FMCW LIDAR 11 (the moving body 1 on which the FMCW LiDAR 11 is mounted) will be described with reference to FIG. 12.

A of FIG. 12 illustrates a situation in which the object (dynamic obstacle) 131 is irradiated with light from the FMCW LiDAR 11, and F motion vectors 221-1 to 221-3 in the ray direction of the light are obtained. The F motion vector 221-1 is a component obtained by projecting an actual motion vector 223-1 of the moving object 131 in the ray direction. The F motion vector 221-2 is a component obtained by projecting an actual motion vector 223-2 of the moving object 131 in the ray direction. The F motion vector 221-3 is a component obtained by projecting an actual motion vector 223-3 of the moving object 131 in the ray direction.

B of FIG. 12 is a diagram in which the start points of the F motion vectors 221-1 to 221-3 obtained by the FMCW LiDAR 11 are matched. In the example illustrated in B of FIG. 12, since the F motion vector 221-1 is the longest, it can be estimated that the moving object 131 is moving in the direction of the F motion vector 221-1.

In this way, the motion direction of the moving object can be detected by obtaining the F motion vector from the plurality of distance measurement points.

### In Case of One Distance Measurement Point

Calculation of a moving direction and speed of an object and trajectory planning according to the calculated moving direction and speed will be described separately for a case where an F motion vector is obtained from one distance measurement point, a case where an F motion vector is obtained from two distance measurement points, and a case where an F motion vector is obtained from three distance measurement points.

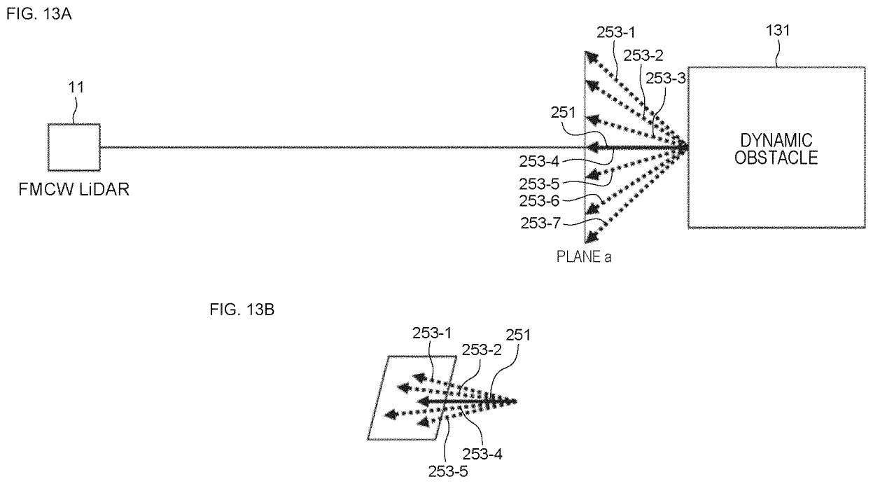

A case where an F motion vector is obtained from one distance measurement point will be described with reference to FIG. 13. A situation illustrated in A of FIG. 13 is a state in which the object (dynamic obstacle) 131 is irradiated with light from the FMCW LiDAR 11 and an F motion vector 251 in the ray direction of the light is obtained, and illustrates a case where there is one distance measurement point.

In a case where the F motion vector 251 obtained by the FMCW LiDAR 11 is only from one distance measurement point, the actual motion vectors from which the F motion vector 251 may be calculated are distributed on a plane orthogonal to the ray direction. In the example illustrated in A of FIG. 13, actual motion vectors 253-1 to 253-7 are illustrated. All of these actual motion vectors 253-1 to 253-7 become the F motion vector 251 when projected onto the ray.

The actual motion vectors 253-1 to 253-7 are vectors from the distance measurement point to a plane a that perpendicularly intersects the ray, in other words, the F motion vector 251. That is, the number of the actual motion vectors 253 representing the moving direction and the speed of the moving object 131 is not limited to one, and all the vectors having the distance measurement point of the moving object 131 as a start point and reaching the plane a are candidates.

As illustrated in B of FIG. 13, when the start point of the F motion vector 251 obtained by the FMCW LiDAR 11 and the start points of the actual motion vectors 253-1 to 253-5 that are candidates for the actual motion vector of the moving object 131 are matched and overlapped, one plane a is determined at the position where the vector reaches. It can be estimated from the F motion vector 251 that the moving object 131 is moving in the direction indicated by the plane a. Furthermore, a relative velocity with respect to the moving object 131 can also be calculated from the F motion vector 251.

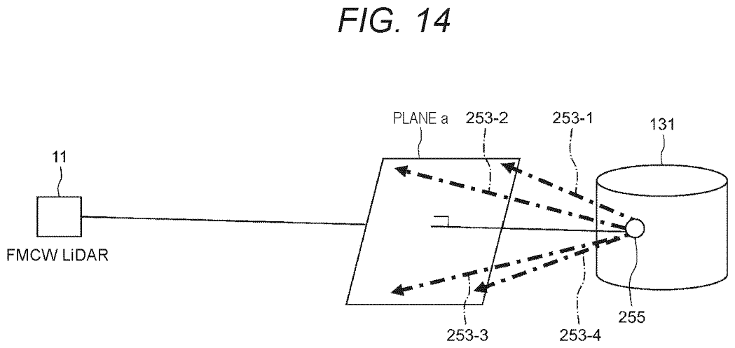

In a case where the distance measurement point at which the F motion vector is obtained is one point, the moving direction and the relative velocity of the object can be estimated to be on a plane. A method of avoiding an obstacle in such a case, in other words, a trajectory planning will be described with reference to FIG. 14.

As illustrated in FIG. 14, when the distance measurement point on the object 131 is only one point of a distance measurement point 255, there are an infinite number of motion vectors that are candidates for the actual motion vector 253. FIG. 14 illustrates candidate actual motion vectors 253-1 to 253-4. As described with reference to FIG. 13, the plane a is estimated from the candidate actual motion vectors, and it can be estimated that the moving object 131 is moving on the basis of the direction and the speed of the plane a.

In a case where the candidate actual motion vector includes a component toward the moving body 1 equipped with the FMCW LiDAR 11, the plane a indicates that there is a possibility that the moving object 131 is moving in a direction toward the moving body 1.

In a case where the motion vector can be detected only from one distance measurement point when the moving object 131 is scanned, it is possible to estimate whether or not the moving object 131 is moving toward the moving body 1 (own device). As described above, in a case where the distance measurement point is only one and the motion component toward the own device is detected, if the moving body 1 moves while maintaining the moving direction and the speed, it is considered that the moving body 1 and the moving object 131 may approach each other and collide in the worst case.

In such a case, as a trajectory route of the moving body 1, a route such as temporarily stopping or decelerating is planned. For example, until a plurality of rays hits the moving object 131, in other words, until the distance measurement points become three or more points, a deceleration instruction is issued in the moving body 1.

A situation in which there is only one distance measurement point from which the motion vector is obtained is considered to occur, for example, in a case where the moving object 131 is located at a position away from the moving body 1 or in a case where the moving object 131 is small. In a case where the moving body 1 decelerates and the moving object 131 approaches, when the number of distance measurement points increases to two or three and the number of distance measurement points increases, the moving speed and the direction of the moving object 131 can be estimated more accurately as described later. In view of the above, in a case where there is only one distance measurement point and it is determined that there is a possibility that the moving object 131 is approaching the own device, an instruction to decelerate the speed of the own device or stay at the current position is issued.

Since the moving object 131 is located at a position away from the moving body 1, in a case where only one distance measurement point can be obtained, the speed of the moving body 1 may be set according to the speed of the moving object 131. Even if the moving object 131 is located at a position away from the moving body 1, in a case where the speed of the moving object 131 is high, in other words, in a case where the motion component is large, the time until the moving object 131 approaches the moving body 1 is short. In such a case, control is performed such that the speed of the moving body 1 is reduced. On the other hand, in a case where the moving object 131 is located at a position away from the moving body 1 and the speed of the moving object 131 is low, in other words, in a case where the motion component is small, the time until the moving object 131 approaches the moving body 1 is long. In such a case, control is performed such that the speed of the moving body 1 is not reduced too much.

As described above, the speed of the moving body 1, for example, the upper limit speed of the moving body 1 can be changed according to the size of the motion component of the moving object 131.

### In Case of Two Distance Measurement Points

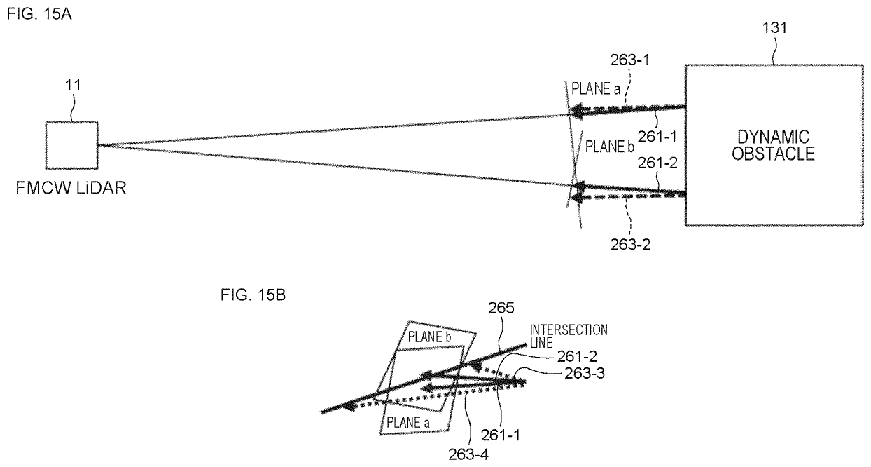

Next, a case where distance measurement points are two points will be described. A of FIG. 15 is a state in which the object (dynamic obstacle) 131 is irradiated with light from the FMCW LiDAR 11, and an F motion vector 261-1 and an F motion vector 261-2 in the ray direction of the light are obtained, and illustrates a case where distance measurement points are two points.

The actual motion vectors that may be calculated from the F motion vector 261-1 obtained by the FMCW LIDAR 11 are distributed on the plane a orthogonal to the ray direction. In the example illustrated in A of FIG. 15, only an actual motion vector 263-1 is illustrated. However, when all of the actual motion vectors 263-1 having the distance measurement point as the start point and reaching the plane a are projected onto the ray, the F motion vector 261-1 is obtained.

Similarly, the actual motion vectors that may be calculated from the F motion vector 261-2 obtained by the FMCW LiDAR 11 are distributed on a plane b orthogonal to the ray direction. In the example illustrated in A of FIG. 15, only an actual motion vector 263-2 is illustrated. However, when all of the actual motion vectors 263-2 having the distance measurement point as the start point and reaching the plane b are projected onto the ray, the F motion vector 261-2 is obtained.

That is, in a case where there are two distance measurement points, the F motion vector 261-1 and the F motion vector 261-2 are obtained from the two distance measurement points, and the plane a including the candidate actual motion vector 263-1 for the F vector 261-1 and the plane b including the candidate actual motion vector 263-2 for the F vector 261-2 can be estimated.

As illustrated in B of FIG. 15, when the start points of the F motion vectors 261-1 and 261-2 obtained by the FMCW LiDAR 11 and the start points of the actual motion vectors 263-1 and 263-2 that are candidates for the actual motion vector of the moving object 131 are matched and overlapped, the plane a and the plane b are respectively determined at the position where the vector reaches. From the plane a and the plane b, an intersection line 265 where the plane a and the plane b intersect can be estimated.

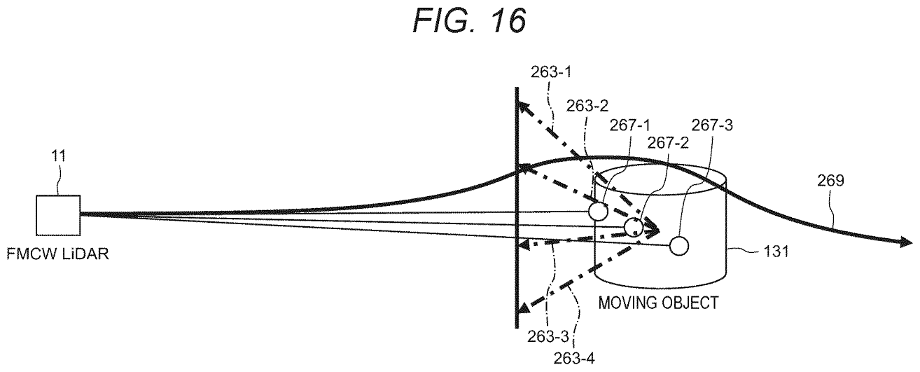

A vector indicating a point on the intersection line 265 is the actual motion vector 263 representing the moving direction and the speed of the moving object 131. In a case where the F motion vector is obtained from the two distance measurement points, it can be estimated that the moving direction and the relative velocity of the object are on the intersection line 265. A method of avoiding an obstacle in such a case, in other words, a trajectory planning will be described with reference to FIG. 16.

In the example illustrated in FIG. 16, a case where one scan line hits the moving object 131 is illustrated. A distance measurement point 267-1, a distance measurement point 267-2, and a distance measurement point 267-3 illustrated on the moving object 131 are on one scan line (one straight line). In such a case, the plane a, the plane b, and the plane c can be estimated from the three distance measurement points 267, and for example, there is a possibility that two intersection lines of an intersection line ab where the plane a and the plane b intersect and an intersection line ac where the plane a and the plane c intersect may be estimated, but the intersection line ab and the intersection line ac may be substantially the same straight line.

In such a case, as in the case described with reference to FIG. 15, it can be estimated that the moving direction and the relative velocity of the moving object 131 are on the intersection line. The example illustrated in FIG. 16 indicates that there are actual motion vectors 263-1 to 263-4 that are candidates for the actual motion vector of the moving object 131 on the intersection line 265.

In the case of the example illustrated in FIG. 16, in the lateral direction (the same direction as the scan line) of the actual motion vector 263, it can be uniquely estimated that the motion direction of the moving object 131 is a direction in which the intersection line 265 is located, but in the vertical direction (the direction perpendicular to the scan line), the estimation is in a degree such that the motion direction of the moving object 131 is any direction on the intersection line 265. In this case, it is not possible to accurately estimate in which direction the moving object 131 is moving in the vertical direction.

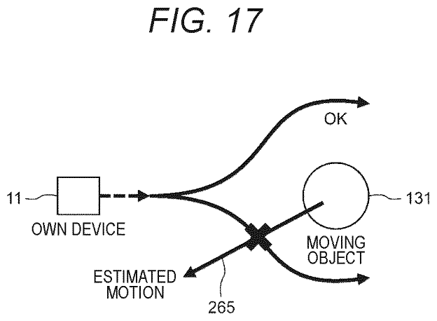

In such a case, a movement route 269 that moves in a direction avoiding the direction in which the intersection line 265 is located is planned by the trajectory planning unit 15. FIG. 17 is a diagram illustrating a situation when viewed from the upper direction corresponding to a case where the situation illustrated in FIG. 16 is a situation when viewed from the lateral direction. As illustrated in FIG. 17, the direction estimated as the motion direction of the moving object 131 is the direction in which the intersection line 265 is located, and is the direction toward the lower left direction in the drawing. A trajectory that does not move in a direction intersecting the intersection line 265 is planned. In the case of the example illustrated in FIG. 17, since the moving object 131 is estimated to move in the lower left direction in the drawing, a trajectory on which the moving body 1 moves in the upper right direction in the drawing is planned.

As described above, in a case where a motion vector is detected from distance measurement points on one scan line when an object is scanned, in other words, in a case where a motion vector is not detected from distance measurement points on a plurality of scan lines, in other words, in a case where there are only two distance measurement points hit by the object, a motion component in a direction orthogonal to the scan plane cannot be specified, but at least in which direction the object moves on the scan plane can be estimated. In such a case, since it can be estimated in which direction the object is moving on the scan plane hit by the object, if the route is changed to a direction so as to avoid the estimated direction, it is possible to avoid the moving object 131 without hindering the movement of the moving object 131.

### In Case of Three Distance Measurement Points

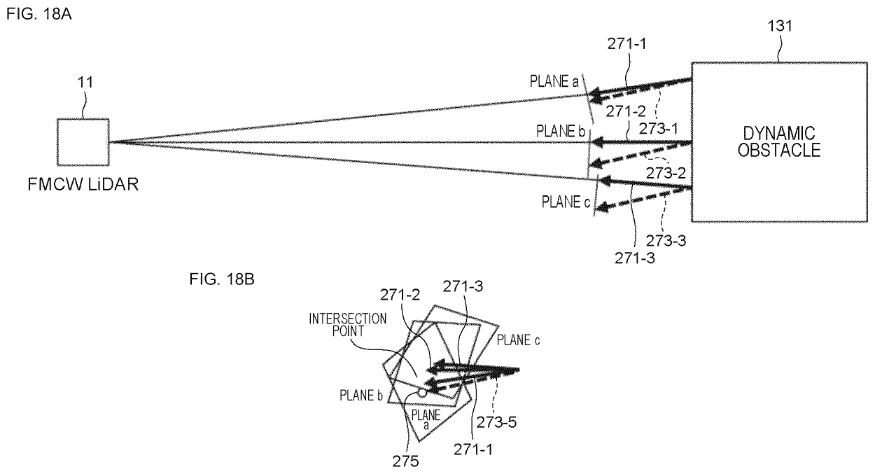

Next, a case where distance measurement points are three points will be described. A situation illustrated in A of FIG. 18 is a situation in which the object (dynamic obstacle) 131 is irradiated with light from the FMCW LiDAR 11 and an F motion vector 271-1, an F motion vector 271-2, and an F motion vector 271-3 in the ray direction of the light is obtained, and illustrates a case where there are three distance measurement points. These three distance measurement points are distance measurement points that are not on one straight line.

The actual motion vectors that may be calculated from the F motion vector 271-1 obtained by the FMCW LiDAR 11 are distributed on the plane a orthogonal to the ray direction. In the example illustrated in A of FIG. 18, only an actual motion vector 273-1 is illustrated. However, when all of the actual motion vectors 273-1 having the distance measurement point as the start point and reaching the plane a are projected onto the ray, the F motion vector 271-1 is obtained.

Similarly, the actual motion vectors that may be calculated from the F motion vector 271-2 obtained by the FMCW LIDAR 11 are distributed on the plane b orthogonal to the ray direction. In the example illustrated in A of FIG. 18, only an actual motion vector 273-2 is illustrated. However, when all of the actual motion vectors 273-2 having the distance measurement point as the start point and reaching the plane b are projected onto the ray, the F motion vector 271-2 is obtained.

Similarly, the actual motion vectors that may be calculated from the F motion vector 271-3 obtained by the FMCW LIDAR 11 are distributed on a plane c orthogonal to the ray direction. In the example illustrated in A of FIG. 18, only an actual motion vector 273-3 is illustrated. However, when all of the actual motion vectors 273-3 having the distance measurement point as the start point and reaching the plane c are projected onto the ray, the F motion vector 271-3 is obtained.

That is, in a case where there are three distance measurement points, the F motion vectors 271-1 to 271-3 are each obtained from the three distance measurement points, and the plane a including the candidate actual motion vector 273-1 for the F vector 271-1, the plane b including the candidate actual motion vector 273-2 for the F vector 271-2, and the plane c including the candidate actual motion vector 273-3 for the F vector 271-3 can be estimated.

As illustrated in B of FIG. 18, when the start points of the F motion vectors 271-1 to 271-3 obtained by the FMCW LiDAR 11 and the start points of the actual motion vectors 273-1 to 273-3 that are candidates for the actual motion vector of the moving object 131 are matched and overlapped, the plane a, the plane b, and the plane c are respectively determined at the position where the vector reaches. From the planes a, the plane b, and the plane c, an intersection point 275 at which the planes intersect can be estimated.

The intersection point 275 at which the planes a to c intersect can be obtained from the following Expression.

[Mathematical Expression 1]

n₁ₓx+n_{1y}y+n_{1z}z+d₁=0 Equation of plane a

n₂ₓx+n_{2y}y+n_{2z}z+d₂=0 Equation of plane b

n₃ₓx+n_{3y}y+n_{3z}z+d₃=0 Equation of plane c

In the equation of the plane a, n₁ₓ is a coefficient, and d₁ represents an offset amount. Similarly, in the equation of the plane b, n₂ₓ is a coefficient, de represents an offset amount, and in the equation of the plane c, n₃ₓ is a coefficient, and d₃ represents an offset amount. Since the planes a to c have been obtained, the coefficients and the offset amounts can be uniquely obtained. By solving these simultaneous equations, a point (x, y, z) at which the three planes intersect can be obtained. The obtained point (x, y, z) is the intersection point 275 and represents the direction of the actual motion vector 273.

Note that, in consideration of the presence of a measurement error, by using an optimization method such as RANSAC from a set of four or more distance measurement points, the coordinates of the intersection point 275 can be obtained more accurately, and the direction of the actual motion vector 273 can be obtained.

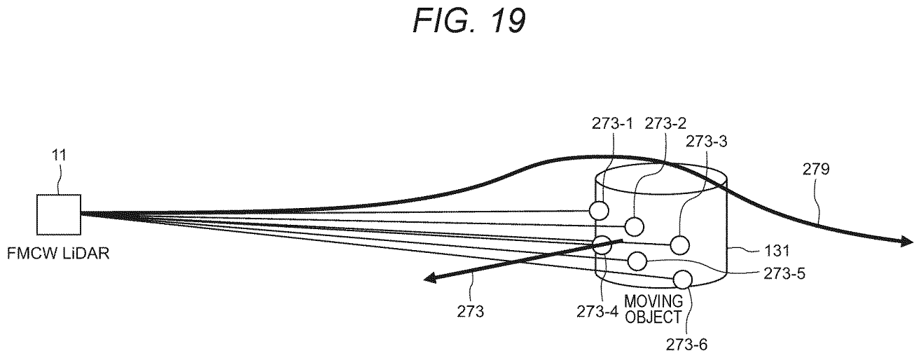

A vector indicating the intersection point 275 is the actual motion vector 273 representing the moving direction and the speed of the moving object 131. In a case where the F motion vector is obtained from three distance measurement points that are not on one straight line, it can be uniquely estimated that the moving direction and the relative velocity of the object are on the intersection point 275. A method of avoiding an obstacle in such a case, in other words, a trajectory planning will be described with reference to FIG. 19.

In the example illustrated in FIG. 19, a case where a plurality of (two in FIG. 19) scan lines hits the moving object 131 is illustrated. Distance measurement points 277-1 to 277-3 illustrated on the moving object 131 are on one scan line, and distance measurement points 277-4 to 277-6 are on the other scan line. In such a case, from among the distance measurement points 277-1 to 277-6, the plane a, the plane b, and the plane c can be estimated from three distance measurement points 277 that are not on one straight line, and the intersection point 275 at which the plane a, the plane b, and the plane c intersect can be estimated.

In such a case, as in the case described with reference to FIG. 18, the moving direction and the relative velocity of the moving object 131 can be estimated to be on the intersection point 275, and can be estimated in one direction. That is, one actual motion vector 273 can be estimated as the moving direction of the moving object 131.

In such a case, a movement route 279 that moves so as to avoid the direction indicated by the actual motion vector 273 is planned by the trajectory planning unit 15. A situation when viewed from the upper direction corresponding to a case where the situation illustrated in FIG. 19 is a situation when viewed from the lateral direction can be estimated to be a situation as illustrated in FIG. 17. Referring to FIG. 17 again, the motion direction of the moving object 131 is a direction in which the actual motion vector 273 is directed (in FIG. 17, the direction in which the intersection line 265 is located). A trajectory that does not move in a direction intersecting the actual motion vector 273 is planned. In the case of the example illustrated in FIG. 17, since the moving object 131 is estimated to move in the lower left direction in the drawing, a trajectory on which the moving body 1 moves in the upper right direction in the drawing is planned.

Alternatively, as illustrated in FIG. 19, in a case where the actual motion vector 273 is in the downward direction, a movement route 279 that moves above the moving object 131 may be planned while avoiding the moving object 131.

As described above, in a case where a motion vector is detected from a plurality of distance measurement points not on one straight line when the object is scanned, a motion component in a direction orthogonal to the scan plane can also be specified. In such a case, since it can be uniquely estimated in which direction the object is moving, if the route is changed to a direction so as to avoid the estimated direction, it is possible to avoid the moving object 131 without hindering the movement of the moving object 131.

Note that, here, a case where there are three distance measurement points has been described as an example. However, in a case where there are three or more distance measurement points, the motion direction and the speed of the object can be obtained more accurately.

As described above, the accuracy of the estimation of the moving direction of the object is different and the planned trajectory is also different according to the case where the distance measurement points are one point, two points, three points or more. Therefore, in order to predict the motion of the object with different prediction accuracy according to the number of distance measurement points, the processing is branched according to the number of distance measurement points. The description returns to the description with reference to the flowchart illustrated in FIG. 3.

When one moving object is selected as a processing target from the moving object instance list in step S17, it is determined in step S18 whether or not there are three or more points that are not on one straight line among the distance measurement points on the moving object. In a case where it is determined in step S18 that there are three or more points that are not on one straight line among the distance measurement points on the moving object, the process proceeds to step S19.

In step S19, the moving object motion prediction unit 13 performs three-dimensional motion estimation of the moving object. The processing in step S19 is processing in a case where there are three or more distance measurement points described with reference to FIG. 18.

In step S19, since there are three or more distance measurement points, the motion of the object can be estimated in three dimensions. In step S20, the predicted trajectory of the moving object is defined as a risk area on the static environment map. After the processing of step S20, the process proceeds to step S21.

In step S21, it is determined whether or not risk assessment has been completed for all the moving objects among the moving object instance list. In a case where it is determined in step S21 that the risk assessment has been completed for all the moving objects among the moving object instance list, the process proceeds to step S15.

As described above, in a case where the process proceeds to step S15 through the processing of step S19, the trajectory planning for the moving object on which the processing of step S19 has been performed is performed as described with reference to FIG. 19.

On the other hand, in a case where it is determined in step S21 that there is a moving object that has not been subjected to the risk assessment among the moving object instance list, the process returns to step S17, the moving object that has not been subjected to the risk assessment is set as a new processing target, and the subsequent processing is repeated.

On the other hand, in a case where it is determined in step S18 that there are not three or more points that are not on one straight line among the distance measurement points on the moving object, the process proceeds to step S22. In step S22, it is determined whether or not the distance measurement points on the moving object are one scan line or only two points. In a case where it is determined in step S22 that the distance measurement points on the moving object are one scan line or only two points, the process proceeds to step S23.

In step S23, a candidate motion vector of the moving object is calculated. The processing in step S23 is processing in a case where there are two distance measurement points or in a case where there is a distance measurement point on one scan line, which are described with reference to FIGS. 15 and 16, and the calculation of the candidate motion vector of the moving object is to obtain the intersection line 265 and obtain a motion vector toward a point on the intersection line 265.

In step S23, since the processing is processing in a case where there are two distance measurement points or there is a distance measurement point on one scan line, the motion of the object toward the point on the intersection line 265 can be estimated. In step S23, the trajectory prediction range of the moving object is defined as a risk area on the static environment map. After the processing of step S24, the process proceeds to step S21.

In step S21, it is determined whether or not risk assessment has been completed for all the moving objects among the moving object instance list. In a case where it is determined in step S21 that the risk assessment has been completed for all the moving objects among the moving object instance list, the process proceeds to step S15.

As described above, in a case where the process proceeds to step S15 through the processing of step S23, the trajectory planning for the moving object on which the processing of step S23 has been performed is performed as described with reference to FIGS. 16 and 17.

On the other hand, in a case where it is determined in step S22 that the distance measurement points on the moving object are not only one scan line or two points, that is, in a case where it is determined that the distance measurement point on the moving object is one point, the process proceeds to step S25.

In step S25, the upper limit speed is changed according to the size of the detected motion component. The processing in step S25 is processing in a case where there is only one distance measurement point described with reference to FIG. 13. For example, in a case where the detected motion component is large, the upper limit speed of the moving body 1 is set to speed close to zero (speed at which the moving body 1 stays on the current position). In a case where the detected motion component is small, the upper limit speed of the moving body 1 is set to speed slightly slower than the upper limit speed set at that time.

After the processing of step S25, the process proceeds to step S21. In step S21, it is determined whether or not risk assessment has been completed for all the moving objects among the moving object instance list. In a case where it is determined in step S21 that the risk assessment has been completed for all the moving objects among the moving object instance list, the process proceeds to step S15.

As described above, in a case where the process proceeds to step S15 through the processing of step S25, the trajectory planning for the moving object on which the processing of step S25 has been performed is performed as described with reference to FIG. 14.

The trajectory planning unit 15 (FIG. 2) selects an optimal route toward the goal while avoiding obstacles, and supplies a control instruction to be taken at this point of time to the control unit 17. In a case where there is no dynamic obstacle, that is, in the case of the processing based on the flowchart illustrated in FIG. 3, in a case where it is determined in step S14 that there is no moving object, the process proceeds to step S15 and trajectory planning is performed, the trajectory planning unit 15 plans the shortest and optimal route and the like for flying toward the goal while avoiding the obstacle on the static environment map. A search algorithm called A* or the like can be appropriately applied to this plan.

In a case where there is a dynamic obstacle having a collision risk, the trajectory planning unit 15 executes the processing of steps S17 to S21 based on the flowchart illustrated in FIG. 3. As described above, in the processing of steps S17 to S21, the accuracy of the motion prediction of the moving object changes according to how many distance measurement points of the FMCW LIDAR 11 are present in the moving object, and thus, trajectory planning suitable for the system is performed. Finally, by selecting a route with the lowest risk in consideration of the motion prediction results of a plurality of the moving objects while avoiding the obstacle on the static environment map, the moving object is also avoided, and the route toward the goal is selected.

In this way, the distance measurement is performed using the FMCW LiDAR 11, and the moving direction and the speed of the object are estimated from the information of the motion vector obtained as a result. At the time of the estimation, different estimation processing is executed according to the number of distance measurement points, and trajectory planning is performed on the basis of the estimation processing.

Such processing up to the trajectory planning, that is, the processing of the flowchart illustrated in FIG. 3 is processing performed for one frame. According to the present technology, when data of one frame is obtained, it is possible to estimate the moving direction and the speed of the object and to make a trajectory planning avoiding the moving direction of the object. Therefore, even in an environment where a moving object is present, it is possible to immediately detect the moving object, determine the moving direction of the moving object, and select a safe route. Furthermore, it is possible to reduce the delay and to immediately respond to a complex motion change of the object.

### Second Embodiment

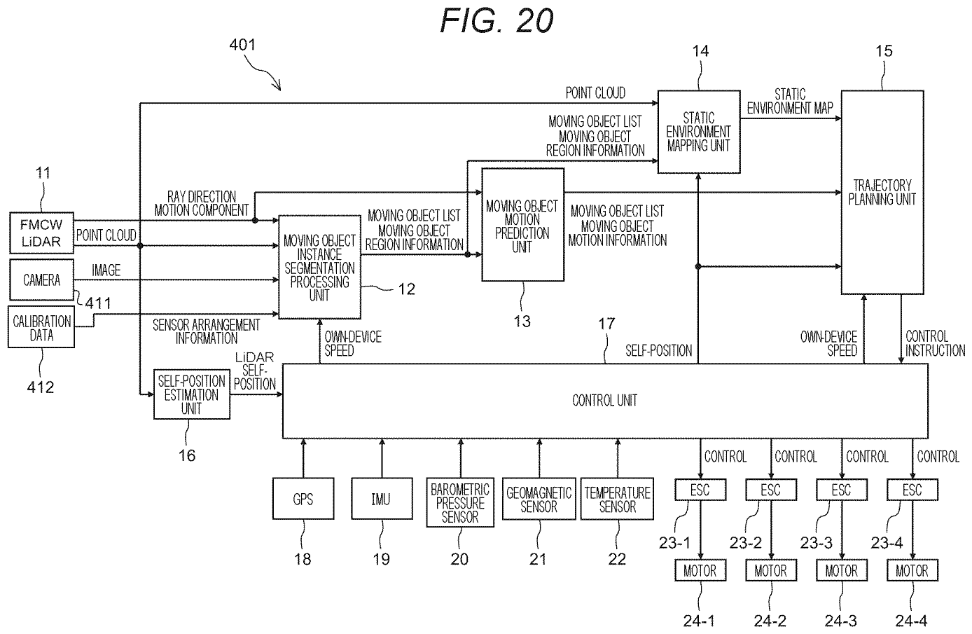

FIG. 20 is a diagram illustrating a configuration example of a moving body 401 in a second embodiment. The moving body 401 illustrated in FIG. 20 has a configuration in which a camera 411 and a calibration data supply unit are added to the moving body 1 illustrated in FIG. 2, and other points are configured in a similar manner.

In the moving body 401 illustrated in FIG. 20, an image is captured by the camera 411, and the acquired image data is supplied to the moving object instance segmentation processing unit 12. Furthermore, sensor arrangement information is also supplied from the calibration data supply unit 412 to the moving object instance segmentation processing unit 12.

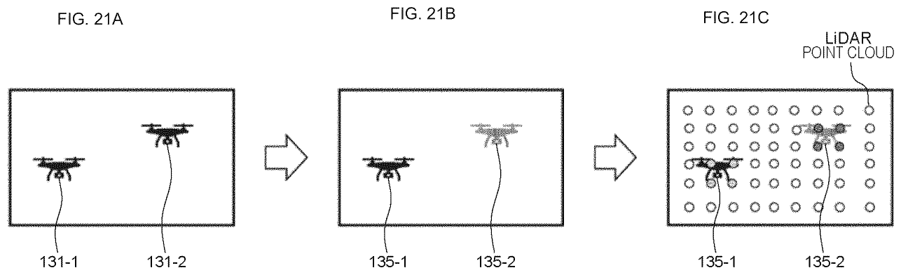

The processing by the moving object instance segmentation processing unit 12 will be described with reference to FIG. 21. A of FIG. 21 illustrates an example of an image captured by the camera 411. The moving object 131-1 and the moving object 131-2 are captured in the image. When the image data of such an image is supplied from the camera 411 to the moving object instance segmentation processing unit 12, the moving object instance segmentation processing unit 12 analyzes the image based on the supplied image data and extracts the instance 135-1 and the instance 135-2 as illustrated in B of FIG. 21. The image analysis can use machine learning.

The point cloud from the FMCW LiDAR 11 is also supplied to the moving object instance segmentation processing unit 12. As illustrated in C of FIG. 21, by projecting the LIDAR point cloud onto an image using the inter-sensor arrangement information, it is possible to determine to which instance each point belongs. For example, it can be seen that four LiDAR points belong on the instance 135-1, and four LiDAR points belong on the instance 135-2. The LiDAR points that are determined to be belonging to the instance 135 are used as the information of the moving object and used for each processing described above.

The camera 411 is provided, and by using the image data captured by the camera 411, the detection of the instance is performed using the image data, and as a result, the LiDAR points located in the region detected as the instance can be detected and used as the information of the moving object.

In a case where an instance is detected using only the LiDAR points from the FMCW LIDAR 11 described with reference to FIG. 8, it is necessary to calculate the motion component of each LIDAR point in one frame in the processing of dividing the LiDAR points into the dynamic region and the static region. However, by a configuration using the image data from the camera 411, the processing of calculating the motion component of each LIDAR point can be omitted, and the processing related to the detection of the instance can be reduced. Therefore, it is possible to detect a moving object at a higher speed and calculate a route for avoiding the moving object.

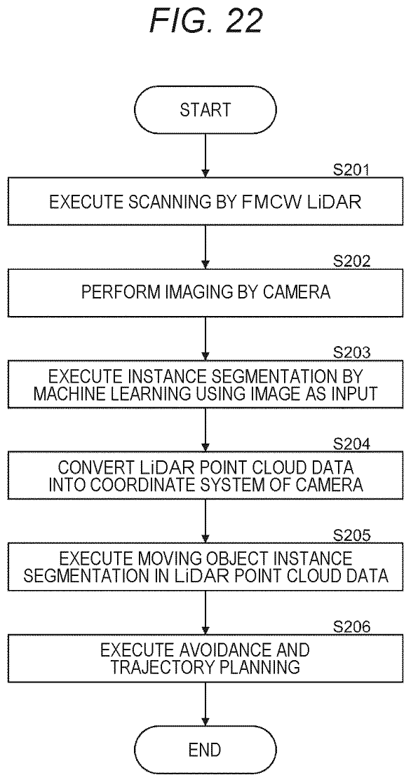

The operation of the moving body 401 illustrated in FIG. 20 will be described with reference to the flowchart of FIG. 22. In step S201, scanning by the FMCW LiDAR 11 is executed, and the point cloud of LiDAR points is supplied to the moving object instance segmentation processing unit 12.

In step S202, imaging by the camera 411 is performed, and the image data is supplied to the moving object instance segmentation processing unit 12.

In step S203, the moving object instance segmentation processing unit 12 executes instance segmentation by machine learning using an image as an input. The processing of step S203 is performed as described with reference to A of FIG. 21 and B of FIG. 21.

In step S204, the LiDAR point cloud data is converted into the coordinate system of the camera, and in step S205, the moving object instance segmentation in the LiDAR point cloud data is executed. The processing of steps S204 and S205 is performed as described with reference to C of FIG. 21.

When the instance of the moving object is detected in this way, processing for the detected instance is executed. In step S206, avoidance and trajectory planning processing is executed. The avoidance and trajectory planning processing executed in step S206 is processing of steps S15 to S25 of the flowchart in FIG. 3, and since this processing has already been described, the description thereof will be omitted.

In this way, it is also possible to configure such that an image is captured by the camera 411 and an instance is detected using the image.

Rotating objects such as a propeller of a drone and a tire of a car may become noise. For such an object, the positions of the propeller and the tire may be specified by image recognition or the like using an image obtained by the camera 411, and such a region may be excluded from the motion estimation region when the motion of the object is estimated. In this way, motion estimation from which noise has been removed can be performed, and motion estimation with higher accuracy can be performed.

In a case where the camera 411 is provided and the Captured image is analyzed to detect a moving object, for example, when the camera 411 of the moving body 401 processes an image captured in a state in which two moving objects overlap, it is possible to detect that there are two moving objects.

Here, the case has been described where the camera 411 is provided and the image from the camera 411 is used as an example, but a light reflection intensity image obtained by the EMCW LiDAR 11 may be used instead of the image from the camera 411.

In the above-described embodiment, the case where there is one FMCW LIDAR 11 has been described as an example, but a plurality of FMCW LiDARs 11 may be provided. For example, the FMCW LIDAR 11 may be provided in each of the front, rear, left, and right directions of the moving body 11, and the above-described processing may be executed in each FMCW LiDAR 11.

### Third Embodiment

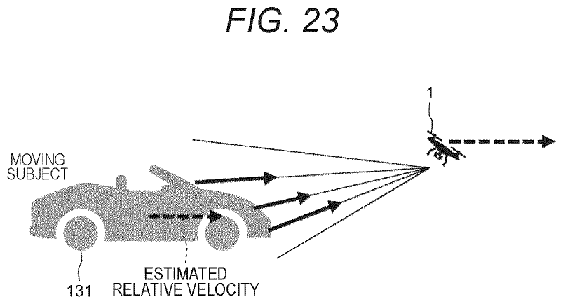

A case where the above-described moving body 1 (the moving body 401) tracks an object will be described with reference to FIG. 23. As illustrated in FIG. 23, a case is considered where the moving object 131 is a vehicle, and the moving body 1 performs imaging in a state in which a certain distance is maintained in accordance with traveling of the moving object 131.

The state in which a certain distance is maintained is a state in which the relative velocity between the moving body 1 and the moving object 131 is maintained at zero. When the moving object 131 moves in the right direction in the drawing at a velocity v, the moving body 1 also moves in the right direction in the drawing at velocity v, so that tracking can be performed in a state in which the relative velocity is maintained at zero.

As described above, the moving body 1 can calculate the relative velocity with respect to the moving object 131 from the Doppler information of each point cloud of the FMCW LiDAR 11. By controlling the own device so that the calculated relative velocity is always zero, it is possible to perform tracking with high accuracy and perform imaging.

For example, the moving body 1 may include the FMCW LiDAR 11 on the moving object 131 side and the FMCW LiDAR 11 on the moving direction side. With such a configuration, it is possible to perform processing of maintaining the relative velocity with respect to the moving object 131 at zero using the FMCW LiDAR 11 provided on the moving object 131 side, and perform processing of performing movement that avoids an obstacle on the moving direction side using the EMCW LiDAR 11 provided on the moving direction side.

By applying the present technology, it is possible to estimate the motion of the moving object in a single frame, and thus, it is possible to perform high-speed tracking and proximity tracking. Furthermore, if the tracked moving object performs a nonlinear movement, the tracking moving body can quickly respond to and follow the movement.

### Recording Medium

The above-described series of processing can be executed by hardware or software. In a case where the series of processing is executed by software, a program constituting the software is installed in a computer. Here, examples of the computer include a computer incorporated in dedicated hardware, a computer that can execute various functions by installation of various programs, for example, a general-purpose personal computer, and the like.

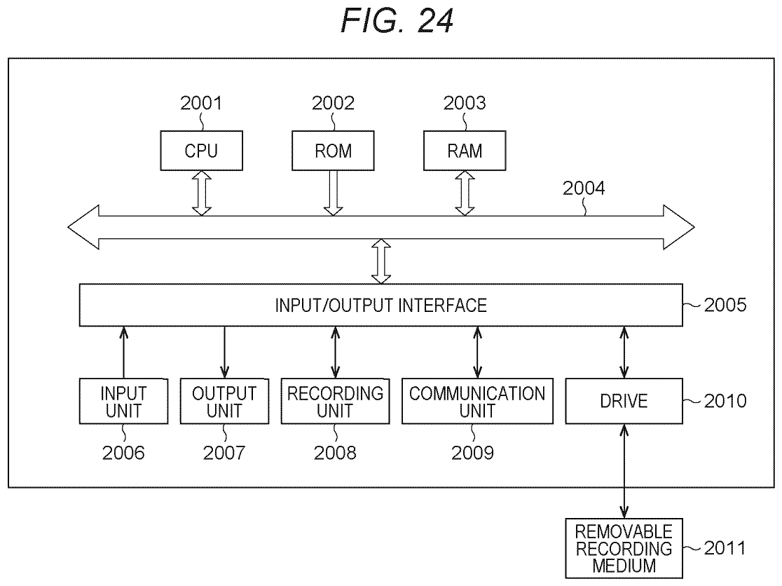

FIG. 24 is a block diagram illustrating a configuration example of the hardware of the computer that executes the above-described series of processing by a program. In the computer, a central processing unit (CPU) 2001, a read only memory (ROM) 2002, and a random access memory (RAM) 2003 are connected to one another by a bus 2004. An input/output interface 2005 is further connected to the bus 2004. An input unit 2006, an output unit 2007, a storage unit 2008, a communication unit 2009, and a drive 2010 are connected to the input/output interface 2005.

The input unit 2006 includes a keyboard, a mouse, a microphone, and the like. The output unit 2007 includes a display, a speaker, and the like. The storage unit 2008 includes a hard disk, a nonvolatile memory, and the like. The communication unit 2009 includes a network interface and the like. The drive 2010 drives a removable medium 2011 such as a magnetic disk, an optical disk, a magneto-optical disk, or a semiconductor memory.

In the computer designed as described above, the CPU 2001 loads, for example, a program stored in the storage unit 2008 into the RAM 2003 via the input/output interface 2005 and the bus 2004, and executes the program, so that the series of processing described above is performed.

The program executed by the computer (CPU 2001) can be provided by being recorded in the removable medium 2011 as a package medium or the like, for example. Furthermore, the program can be provided via a wired or wireless transmission medium such as a local area network, the Internet, or digital satellite broadcasting.

In the computer, the program can be installed in the storage unit 2008 via the input/output interface 2005 by mounting the removable medium 2011 on the drive 2010. Furthermore, the program can be received by the communication unit 2009 via a wired or wireless transmission medium and installed in the storage unit 2008. In addition, the program can be installed in the ROM 2002 or the storage unit 2008 in advance.

Note that the program to be executed by the computer may be a program that performs processing in time-series order described in the present specification, or may be a program that performs processing in parallel or at necessary timing such as when a call is made.

In the present specification, the system represents the entire device including a plurality of devices.

Note that the effects described in the present specification are merely examples and are not limited, and other effects may be provided.

Note that embodiments of the present technology are not limited to the above-described embodiments, and various changes can be made without departing from the gist of the present technology.

Note that the present technology can also have the following configurations.
(1)

An information processing method including:
acquiring information for predicting a motion of an object located in a surrounding from a frequency modulated continuous wave light detection and ranging (FMCW LiDAR);
detecting the object using the information; and predicting the motion of the object with different prediction accuracy according to the number of distance measurement points of the FMCW LiDAR on the object.
(2)

The information processing method according to (1), in which
in a case where the distance measurement point of the FMCW LIDAR is one point on the object, a direction in which a plane including a candidate vector that may be a motion vector is located is set as a prediction result of the motion of the object, the motion vector representing a direction in which the object is moving.
(3)

The information processing method according to (1) or (2), in which
in a case where the distance measurement points of the FMCW LiDAR are two points on the object, a direction in which an intersection line of a first plane obtained from a first distance measurement point and a second plane obtained from a second distance measurement point is located is set as a prediction result of the motion of the object, the first plane and the second plane including a candidate vector that may be a motion vector representing a direction in which the object is moving.
(4)

The information processing method according to any one of (1) to (3), in which
in a case where the distance measurement points of the FMCW LiDAR are three points or more on the object, a direction in which an intersection point where a first plane obtained from a first distance measurement point, a second plane obtained from a second distance measurement point, and a third plane obtained from a third distance measurement point intersect is located is set as a prediction result of the motion of the object, the first plane, the second plane, and the third plane including a candidate vector that may be a motion vector representing a direction in which the object is moving.
(5)

The information processing method according to any one of (1) to (4), in which
the information is a motion component in a ray direction, and the detecting detects the object by detecting a region where the motion component is present.
(6)

The information processing method according to (2), further including
changing an upper limit of speed of a moving body according to a size of the motion component of the object obtained by the FMCW LIDAR at the distance measurement point.
(7)

The information processing method according to (3), further including
planning, as a trajectory of a moving body, a trajectory that avoids a direction in which the intersection line is located.
(8)

The information processing method according to (4), further including
planning, as a trajectory of a moving body, a trajectory that avoids a direction in which the intersection point is located.
(9)

The information processing method according to any one of (1) to (8), in which
the detecting detects the object by analyzing an image captured by a camera, and
the predicting predicts the motion of the object by using data of the FMCW LIDAR at a distance measurement point in a region where the detected object is located.
(10)

The information processing method according to any one of (1) to (9), further including
controlling a moving body such that a relative velocity with respect to the object becomes zero.
(11)

The information processing method according to any one of (6), (7), (8). and (10), in which the moving body is a drone.
(12)

An information processing device including:
a detection unit that acquires information for predicting a motion of an object located around a moving body from a frequency modulated continuous wave light detection and ranging (FMCW LiDAR) included in the moving body, and detects the object using the information; and
a prediction unit that predicts the motion of the object with different prediction accuracy according to the number of distance measurement points of the EMCW LiDAR on the object detected by the detection unit.
(13)

The information processing device according to (12), further including
a trajectory planning unit that plans a trajectory on which the moving body moves in a direction in which the object does not move on the basis of the motion of the object predicted by the prediction unit.
(14)

The information processing device according to (13), further including
a control unit that controls the moving body to move on the trajectory planned by the trajectory planning unit.
(15)

A program for causing a computer to execute processing including the steps of:
acquiring information for predicting a motion of an object located in a surrounding from a frequency modulated continuous wave light detection and ranging (FMCW LIDAR);
detecting the object using the information; and
predicting the motion of the object with different prediction accuracy according to the number of distance measurement points of the FMCW LiDAR on the object.

### REFERENCE SIGNS LIST

1 Moving body
11 FMCW LiDAR
12 Moving object instance segmentation processing unit
13 Moving object motion prediction unit
14 Static environment mapping unit
15 Trajectory planning unit
16 Self-position estimation unit
17 Control unit
18 GPS
20 Barometric pressure sensor
21 Geomagnetic sensor
22 Temperature sensor
23 ESC
24 Motor
101 Object
111 Motion vector
112 Actual motion vector
131 Moving object
133 Static region
135 Instance
201 F motion vector
203 Actual motion vector
211 F motion vector
213 Actual motion vector
221 F motion vector
223 Actual motion vector
251 F motion vector
253 Actual motion vector
255 Distance measurement point
261 F motion vector
263 Actual motion vector
265 Intersection line
267 Distance measurement point
269 Movement route
271 F motion vector
273 Actual motion vector
275 Intersection point
277 Distance measurement point
279 Movement route
401 Moving body
411 Camera
413 Calibration data supply unit

1. An information processing method comprising:
acquiring information for predicting a motion of an object located in a surrounding from a frequency modulated continuous wave light detection and ranging (FMCW LiDAR);
detecting the object using the information; and
predicting the motion of the object with different prediction accuracy according to the number of distance measurement points of the FMCW LiDAR on the object.

2. The information processing method according to claim 1, wherein
in a case where the distance measurement point of the FMCW LiDAR is one point on the object, a direction in which a plane including a candidate vector that may be a motion vector is located is set as a prediction result of the motion of the object, the motion vector representing a direction in which the object is moving.

3. The information processing method according to claim 1, wherein
in a case where the distance measurement points of the FMCW LIDAR are two points on the object, a direction in which an intersection line of a first plane obtained from a first distance measurement point and a second plane obtained from a second distance measurement point is located is set as a prediction result of the motion of the object, the first plane and the second plane including a candidate vector that may be a motion vector representing a direction in which the object is moving.

4. The information processing method according to claim 1, wherein
in a case where the distance measurement points of the FMCW LIDAR are three points or more on the object, a direction in which an intersection point where a first plane obtained from a first distance measurement point, a second plane obtained from a second distance measurement point, and a third plane obtained from a third distance measurement point intersect is located is set as a prediction result of the motion of the object, the first plane, the second plane, and the third plane including a candidate vector that may be a motion vector representing a direction in which the object is moving.

5. The information processing method according to claim 1, wherein
the information is a motion component in a ray direction, and the detecting detects the object by detecting a region where the motion component is present.

6. The information processing method according to claim 2, further comprising
changing an upper limit of speed of a moving body according to a size of the motion component of the object obtained by the FMCW LIDAR at the distance measurement point.

7. The information processing method according to claim 3, further comprising
planning, as a trajectory of a moving body, a trajectory that avoids a direction in which the intersection line is located.

8. The information processing method according to claim 4, further comprising
planning, as a trajectory of a moving body, a trajectory that avoids a direction in which the intersection point is located.

9. The information processing method according to claim 1, wherein
the detecting detects the object by analyzing an image captured by a camera, and
the predicting predicts the motion of the object by using data of the FMCW LIDAR at a distance measurement point in a region where the detected object is located.

10. The information processing method according to claim 1, further comprising
controlling a moving body such that a relative velocity with respect to the object becomes zero.

11. The information processing method according to claim 6, wherein
the moving body is a drone.

12. An information processing device comprising:
a detection unit that acquires information for predicting a motion of an object located around a moving body from a frequency modulated continuous wave light detection and ranging (FMCW LIDAR) included in the moving body, and detects the object using the information; and
a prediction unit that predicts the motion of the object with different prediction accuracy according to the number of distance measurement points of the FMCW LIDAR on the object detected by the detection unit.

13. The information processing device according to claim 12, further comprising
a trajectory planning unit that plans a trajectory on which the moving body moves in a direction in which the object does not move on a basis of the motion of the object predicted by the prediction unit.

14. The information processing device according to claim 13, further comprising
a control unit that controls the moving body to move on the trajectory planned by the trajectory planning unit.

15. A program for causing a computer to execute processing including the steps of:
acquiring information for predicting a motion of an object located in a surrounding from a frequency modulated continuous wave light detection and ranging (FMCW LIDAR);
detecting the object using the information; and
predicting the motion of the object with different prediction accuracy according to the number of distance measurement points of the FMCW LIDAR on the object.
